(19) United States
(12) Patent Application Publication
(10) Pub. No.: US 2015/0180289 A1
(43) Pub. Date: Jun. 25, 2015

(54) NEW DEVICE

(71) Applicant: HÖGANÄS AB (PUBL), Höganäs (SE)

(72) Inventor: Jamie Washington, Sowerby Bridge (GB)

(21) Appl. No.: 14/409,252

(22) PCT Filed: Jun. 20, 2013
(86) PCT No.: PCT/EP2013/062870

§ 371 Date: Dec. 18, 2014

(30) Foreign Application Priority Data
Jun. 21, 2012 (EP) 12172861.2

(51) Int. Cl. H02K 1/14; H02K 1/27; H02K 1/02

(52) U.S. Cl. CPC H02K 1/145; H02K 1/02; H02K 1/2786

(57) ABSTRACT

A stator core component for a stator of a modulated pole machine, the modulated pole machine including the stator and a rotor, the stator and the rotor defining an air gap between respective interface surfaces of the rotor the stator for communicating magnetic flux between the stator and the rotor, wherein the stator core component includes an annular part from which a plurality of teeth extend in a radial direction towards the rotor, the teeth being arranged along a circumference of the annular part, each tooth having an interface surface facing the air gap and adapted to allow magnetic flux to communicate between the stator and the rotor via the air gap, the interface surface of each tooth defining a tooth span in the circumferential direction of the tooth.

### FIELD OF THE INVENTION

This invention generally relates to modulated pole machines. More particularly, the invention relates to a stator for such a modulated pole machine.

### BACKGROUND OF THE INVENTION

Over the years, electric machine designs such as modulated pole machines have attracted more and more interest. Electric machines using the principles of these machines were disclosed as early as about 1890 by W. M. Mordey and 1910 by Alexandersson and Fessenden. One of the most important reasons for the increasing interest is that the design enables a very high torque output in relation to, for instance, induction machines, switched reluctance machines and even permanent magnet brushless machines. Further, such machines are advantageous in that the coil is often easy to manufacture. However, one of the drawbacks of the design is that they are typically relatively expensive to manufacture.

Stators of modulated pole electric machines generally use of a central single coil that magnetically feeds multiple teeth formed by a soft magnetic core structure. The coil is sometimes also referred to as winding. The soft magnetic core is formed around the coil while other common electrical machine structures use a coil that is formed around a tooth of the core component. Examples of the modulated pole machine topology are sometimes recognised as e.g. Claw-pole-, Crow-feet-, Lundell- or Transverse Flux Machines (TFM). A modulated pole machine with buried magnets comprises an active rotor structure including a plurality of permanent magnets being separated by rotor pole pieces.

WO2007/024184 discloses an electrical, rotary machine, which includes a first stator core component being substantially circular and including a plurality of teeth, a second stator core component being substantially circular and including a plurality of teeth, a coil arranged between the first and second circular stator core components, and a rotor including a plurality of permanent magnets. The first stator core component, the second stator core component, the coil and the rotor are encircling a common geometric axis, and the plurality of teeth of the first stator core component and the second stator core component are arranged to protrude towards the rotor. Additionally the teeth of the second stator core component are circumferentially displaced in relation to the teeth of the first stator core component, and the permanent magnets in the rotor are separated in the circumferential direction from each other by axially extending pole pieces made from soft magnetic material.

It is generally desirable to provide a modulated pole machine that is relatively inexpensive in production and assembly. It is further desirable to provide such a machine that has good performance parameters, such as one or more of the following: high structural stability, low magnetic reluctance, efficient flux path guidance, low weight, small size, high volume specific performance, etc. It is further desirable to provide components for such a machine.

One undesirable effect occurring in electrical machines is the so-called cogging torque, i.e. the torque due to the interaction between permanent magnets of the rotor and the iron of the stator. It is also known as detent or ‘no-current’ torque. Cogging torque in an MPM is generated by the interaction of permanent magnets with the toothed iron structure. The permanent magnets try to line up in such a way that the flux flows around the lowest reluctance path possible. Cogging torque can be detrimental to the performance of the machine and it can introduce unwanted vibration and noise. Therefore, reduction of the cogging torque is often desirable. For example, if the machine is used as a generator in a windmill the cogging torque has to be low in order to allow the generator to rotate at very low wind speeds. In case of smaller motors, up to some 50-100 Nm, cogging torque can easily be noticed by rotating the motor by hand.

In the context of a modulated pole machine (MPM), the amount of cogging torque depends on a large variety of factors. Even though some known measures for reducing cogging torque exist, cogging reduction often increases the cost of the machine since the design will be more complex. Examples of methods that add cost and complexity are skewing the rotor and/or the stator. It is thus desirable to reduce the cogging of a modulated pole machine while avoiding an increase in machine complexity and/or cost. It is further desirable to provide a machine that can be manufactured efficiently and at low cost.

Moreover, in many applications it is desirable to reduce the harmonic content of the back electromotive force (back EMF) so as to reduce torque ripple. Consequently, it is desirable to provide a mechanism allowing the reduction of cogging torque and/or the reduction of undesired harmonic content of the back EMF.

### SUMMARY

According to a first aspect, disclosed herein is a stator core component for a stator of a modulated pole machine, the modulated pole machine comprising the stator and a rotor, the stator and the rotor defining an air gap between respective interface surfaces of the rotor the stator for communicating magnetic flux between the stator and the rotor, wherein the stator core component comprises an annular part from which a plurality of teeth extend in a radial direction towards the rotor, the teeth being arranged along a circumference of the annular part, each tooth having an interface surface facing the air gap and adapted to allow magnetic flux to communicate between the stator and the rotor via the air gap, the interface surface of each tooth defining a tooth span in the circumferential direction of the tooth; wherein the stator core component comprises at least a first subset of teeth having a first tooth span and a second subset of teeth having a second tooth span, different from the first tooth span.

Hence, disclosed herein are embodiments of a teeth arrangement of a Modulated Pole Machine (MPM) that allow for a significant reduction of the cogging torque of the machine. Rather than using a conventional tooth style where the teeth of the machine all have the same size and span this method uses a combination of teeth with differing spans. The inventors have realised that a combination of different tooth spans allows cogging torque to be reduced while keeping the harmonic content of the counter electromotive force (“back EMF”) relatively low.

The non-uniform tooth span of the stator components can be made without significantly increasing the manufacturing cost or complexity of the resulting machine. Furthermore, a modification of the rotor is not required.

The inventors have further found that when the tooth span of a modulated pole machine is varied so as to affect the cogging torque, some tooth spans reduce specific harmonics of the waveforms of the cogging torque relative to the position of the rotor. Moreover, it was found that when the tooth span is changed and the harmonics are reduced, the phases of the respective harmonics also change, i.e. the effective direction of the cogging torque may be reversed. Therefore, a combination of tooth spans where the phases of the influential cogging torque harmonics are reversed lead to a cancellation of these harmonics and hence an overall reduced cogging torque. This method can also be used in the same manner to reduce the effect of harmonics in the back EMF waveform of the machine. Certain harmonics in the back EMF also change phase with changes in tooth span and, hence, the tooth span can be used to cancel these harmonics.

Consequently, in some embodiments, the tooth spans of the first and second subsets are selected so as to cause one or more predetermined harmonics of at least one of the cogging torque or the back EMF for a stator having only teeth of the first tooth span to be predominantly out of phase relative to corresponding one or more predetermined harmonics of at least one of the cogging torque or the back EMF for a stator having only teeth of the second tooth span. It will be appreciated that, in certain machine designs, some harmonics may cancel out e.g. due to the effect of different phases of a multiphase machine. Nevertheless, regardless of the overall machine design, one or more harmonics of the cogging torque and/or back EMF waveforms remain and may thus be regarded as dominant harmonics which remain desirable to be reduced or even eliminated by means of varying tooth span as described herein.

In some embodiments, the first subset of teeth is arranged along a first segment of the circumference and the second set of teeth is arranged along a second segment of the circumference, different from the first segment. In particular, the annular stator core component is divided into a number of non-overlapping segments where all teeth within each segment have the same tooth span and teeth in different segments have different tooth span. In one embodiment, the stator core component is divided into two such segments. Such an arrangement of teeth allows for a more efficient simulation of the cogging torque and/or back EMF, e.g. using finite element modelling and, consequently, for a more reliable selection of tooth spans and numbers of teeth in each subset.

In some embodiments the teeth of each of the first and second subsets are distributed along the entire circumference of the stator core component, e.g. in an alternating pattern: in some embodiments, the alternating pattern may be uniform along the entire circumference: For example each tooth of one subset may have two teeth of the other subset as neighbours, or the pattern may otherwise be periodic, e.g. two teeth of one subset may alternate with a single tooth of the other subset. In other embodiments, the alternating pattern may change along the circumference. In particular, it will be appreciated that, in embodiments where the first and second subsets comprise a different number of teeth, the alternating pattern may be non-uniform, e.g. there may be a segment of the circumference where there are more teeth of one of the subsets than of the other subset. A uniform, or at least approximately uniform, distribution of the teeth of each subset along the circumference may result in a more uniform distribution of forces along the circumference.

In some embodiments, the tooth spans of the respective subsets are selected such that they cause different characteristics in the cogging torque, e.g. such that the cogging torque for the respective tooth spans has reversed polarities. In one embodiment, the first subset of teeth have a tooth span larger than 140° and wherein the second subset of teeth have a tooth span smaller than 140°. For example, the teeth of the first subset may have a tooth span of between 110° and 135°, e.g. between 115° and 130°, such as 120°, while the teeth of the second subset may have a tooth span of between 145° and 180°, e.g. between 150° and 175°, such as 170°. Here and in the following, unless explicitly stated otherwise, angles will be expressed in electrical degrees i.e. such that 360° correspond to a rotation of the rotor during a complete electrical cycle. Electrical degrees are equivalent to mechanical degrees divided by the number of pairs of magnetic poles.

In some embodiments the first subset and the second subset comprise an equal number of teeth while, in other embodiments, the first subset of teeth comprises a different number of teeth than the second subset of teeth. In particular, the respective number of teeth to be included in the first and second subsets may be determined based on the magnitude of one or more harmonics of at least one of the cogging torque and the back EMF of a stator having teeth of the first tooth span only and of a stator having teeth of the second tooth span only, respectively. In particular, when the magnitude of the one or more harmonics for the first tooth span is larger than the corresponding magnitude for the second tooth span, the number of teeth having the second tooth span may be selected to be larger than the number of teeth having the first tooth span.

Generally, the size of the first and second tooth spans and the respective numbers of teeth in the first and second subsets may be selected so as to cause one or more predetermined harmonics of at least one of the cogging torque and the back EMF for a stator having only teeth of the first tooth span to predominantly cancel the corresponding one or more predetermined harmonics of at least one of the cogging torque or the back EMF for a stator having only teeth of the second tooth span, e.g. by selecting the tooth spans and numbers of teeth such that a sum of the corresponding harmonics scaled by the respective numbers of teeth is reduced or even minimized. The magnitude of the respective harmonics and/or their scaled sum may be determined as their amplitudes, their energy content, and/or by another suitable measure of the magnitude of a waveform.

It will be appreciated that the stator core component may comprise more than two subsets of teeth each subset comprising a respective number of teeth and each subset of teeth having a respective tooth span, different from the tooth spans of the other subsets. For example, a stator core component may comprise 2, 3, 4, 5 or even more subsets.

In some embodiments, at least some of the teeth are positioned such that they have different pitch distances to their respective neighbouring teeth, e.g. a larger pitch distance to their neighbour on one side than to their neighbour on the opposite side. The inventors have found that a combination of non-uniform tooth spans and variable pitch distances between teeth allow for a further reduction of the cogging torque and/or back EMF. The pitch distance between two teeth may be measured as the angular distance between the centers or between the corresponding side walls of the teeth, e.g. as the distance between the respective trailing side walls of each tooth or between the respective leading side walls of each tooth.

In some embodiments, the stator core component furthers comprise a yoke part that provides a predominantly axial flux path from/to another stator core component comprising another one of the sets of teeth of the same phase. The annular part and the yoke part provide a flux path between neighboring teeth (which are displaced with respect to each other in the direction of motion) of the respective stator core components. The yoke part may e.g. be formed as a flange, e.g. and annular flange, axially protruding from the annular stator core part.

In some embodiments each tooth comprises a leading and a trailing side wall each facing a respective neighbouring tooth, the interface surface and the side walls forming respective leading and trailing edges connecting the interface surface with the leading and trailing side walls, respectively; wherein the tooth span of the tooth is defined as a distance between the leading and trailing edges. In some embodiments, the interface surface has a substantially constant distance from the rotor. The tooth span may be defined as the circumferential extent of the interface surface. In embodiments where the circumferential extent of the interface surface of a tooth varies along the axial direction, the tooth span may be defined as the circumferential extent averaged over the axial width of the tooth. Alternatively, the tooth span may be defined as the angle between the leading and trailing side faces of the tooth. For the purpose of the present description, different measures of tooth span may be employed as long as the same measure of tooth span is used for all teeth.

The present invention relates to different aspects including the stator core component described above and in the following, a stator, a modulated pole machine and/or corresponding devices, methods and/or products, each yielding one or more of the benefits and advantages described in connection with one or more of the above mentioned aspects, and each having one or more embodiments corresponding to the embodiments described in connection with one or more of the other aspects and/or disclosed in the appended claims.

In particular, disclosed herein are embodiments of a stator for a modulated pole machine, the modulated pole machine comprising the stator and a rotor, the stator and the rotor defining an air gap between respective interface surfaces of the rotor the stator for communicating magnetic flux between the stator and the rotor, wherein the stator comprises a stator core comprising at least one annular part from which a plurality of teeth extend in a radial direction towards the rotor, the teeth being arranged along a circumference of the annular part, each tooth having an interface surface facing the air gap and adapted to allow magnetic flux to communicate between the stator and the rotor via the air gap, the interface surface of each tooth defining a tooth span in the circumferential direction of the tooth; wherein the stator core comprises at least a first subset of teeth having a first tooth span and a second subset of teeth having a second tooth span, different from the first tooth span.

The stator core may be manufactured as a single component or from multiple components. The stator may comprise an annular core back from which respective circumferential rows of teeth protrude in the radial direction, where one, some or each row(s) of teeth comprises a first and a second subset of teeth having respective first and second tooth spans, different from each other. In some embodiments, the stator core comprises two or more stator core components as described herein. Embodiments of the stator comprise a coil arranged coaxial with the stator core and axially arranged between two of the rows of teeth. In multi-phase machines, the stator core comprises more than two rows of teeth and more than one coil, each axially sandwiched between respective rows of teeth.

According to yet another aspect, disclosed herein are embodiments of a modulated pole machine that comprises a stator as described above and in the following. In some embodiments, the modulated pole machine is a TFM machine. The TFM topology is an example of a modulated pole machine which has a number of advantages over conventional machines. In a single-sided radial flux stator, a single phase coil is arranged parallel to the air gap and with a more or less U-shaped yoke component surrounding the coil and exposing in principal two parallel rows of teeth's facing the air gap. In some embodiments, the modulated pole machine is a multi-phase machine having two outer phases and one or more central phases. Multi-phase arrangements include magnetically separated single phase units stacked axially, i.e. perpendicular to the direction of motion of the rotor. The phases are then electrically and magnetically shifted, typically by 120°, for a three-phase arrangement to smooth the operation and produce a more or less even force or torque independent of the position of the rotor. In some embodiments, the teeth provide a predominantly radial flux path between the air gap and the annular part, while the annular part provides a predominantly circumferential flux path connecting the radial flux path to/from the teeth with an axial flux path to/from the annular part of another, like stator core component of the same stator or stator phase.

In embodiments of the modulated pole machine, the stator is a multi-phase stator comprising a plurality of phases arranged side-by-side in the axial direction, where the stator comprises a plurality of sets of teeth, wherein the teeth of each set are distributed along the circumferential direction, wherein the plurality of sets of teeth comprises two peripheral sets and a plurality of inner sets arranged in the axial direction between the peripheral sets; where the teeth of the inner sets are wider, in the axial direction, than the teeth of the peripheral sets and provide a common magnetic flux path shared by two neighbouring phases. The teeth of the respective sets are arranged displaced in the direction of motion relative to the teeth of the other sets. At least one of the sets of teeth comprise at least a first and a second subset of teeth having respective tooth spans.

In embodiments of the modulated pole machine, the rotor comprises a plurality of permanent magnets separated from each other in the circumferential direction by rotor pole pieces. The rotor pole pieces may be formed as rods, e.g. rectilinear rods, that are elongated in the axial direction. The plurality of permanent magnets may be arranged so that every second magnet along the circumferential direction is reversed in magnetisation direction. Thereby each individual rotor pole piece only interfaces with magnets showing equal polarity. Generally, the permanent magnets may also be rods elongated in the axial direction; the rods may extend across the axial extent of the air gap.

In some embodiments, the stator comprises: a first stator core component being substantially annular and including a plurality of teeth, a second stator core component being substantially annular and including a plurality of teeth, a coil arranged between the first and second circular stator core components, wherein the first stator core component, the second stator core component, the coil and the rotor are encircling a common geometric axis defined by the longitudinal axis of the rotor, and wherein the plurality of teeth of the first stator core component and the second stator core component are arranged to protrude towards the rotor; wherein the teeth of the second stator core component are circumferentially displaced in relation to the teeth of the first stator core component. The teeth of two stator core components may thus form respective circumferential rows of teeth where the rows are axially spaced apart and separated by the coil of the stator, the coil being accommodated in a circumferentially extending gap between the rows of teeth.

Embodiments of a stator and/or a stator core component described herein can be efficiently manufactured while allowing the reduction of one or both of the cogging torque and the harmonic content of the back EMF. In particular, embodiments of the stator core components described herein are well-suited for production by Powder Metallurgy (P/M) production methods. Accordingly, in some embodiments, the stator, the stator core component and/or the pole pieces of the rotor are made from a soft magnetic material such as soft magnetic powder, thereby simplifying the manufacturing of the components of the modulated pole machine and providing an efficient magnetic flux concentration, utilizing the advantage of effective three-dimensional flux paths in the soft magnetic material allowing e.g. radial, axial and circumferential flux path components in a rotary machine.

The soft magnetic powder may e.g. be a soft magnetic Iron powder or powder containing Co or Ni or alloys containing parts of the same. The soft magnetic powder could be a substantially pure water atomised iron powder or a sponge iron powder having irregular shaped particles which have been coated with an electrical insulation. In this context the term “substantially pure” means that the powder should be substantially free from inclusions and that the amount of the impurities O, C and N should be kept at a minimum. The average particle sizes are generally below 300 μm and above 10 μm. However, any soft magnetic metal powder or metal alloy powder may be used as long as the soft magnetic properties are sufficient and that the powder is suitable for die compaction.

The electrical insulation of the powder particles may be made of an inorganic material. Especially suitable are the type of insulation disclosed in U.S. Pat. No. 6,348,265 (which is hereby incorporated by reference), which concerns particles of a base powder consisting of essentially pure iron having an insulating oxygen- and phosphorus-containing barrier. Powders having insulated particles are available as Somaloy® 500, Somaloy® 550 or Somaloy® 700 available from Hoganas AB, Sweden.

The shaping of the pole pieces, the stator, and/or the stator core components may thus efficiently be implemented by compacting the pole piece or stator core component from soft magnetic powder in a suitable compacting tool, such as a tool using a so-called shaped die.

It is appreciated that the air gap is typically filled with air. However, the skilled person will appreciate that the air gap may be filled with another gas than air. Nevertheless, for the purpose of the present description, the gap between stator and rotor will be referred to as air gap regardless which gas the gap is filled with.

### BRIEF DESCRIPTION OF THE DRAWINGS

The above and/or additional objects, features and advantages of the present invention, will be further elucidated by the following illustrative and non-limiting detailed description of embodiments of the present invention, with reference to the appended drawings, wherein:

FIG. 1 shows an example of a single-phase modulated pole machine.

FIG. 2 shows a schematic view of an example of a stator for a modulated pole machine.

FIG. 3 shows a 3-phase modulated pole machine comprising a stator with 3 sets of stator component pairs, each holding one circumferential coil.

FIG. 4 shows an enlarged view of a portion of an example of stator and a rotor of a modulated pole machine.

FIG. 5 shows a side view of an example of a stator core component.

FIG. 6 shows graphs illustrating the cogging torque of respective examples of a modulated pole machine.

FIG. 7 illustrates a stator where the pitch distance between neighbouring teeth varies.

FIG. 8 shows a stator 10 and a rotor 12 of an example of a 3-phase modulated pole machine having combined phases.

### DETAILED DESCRIPTION

In the following description, reference is made to the accompanying figures, which show by way of illustration how the invention may be practiced.

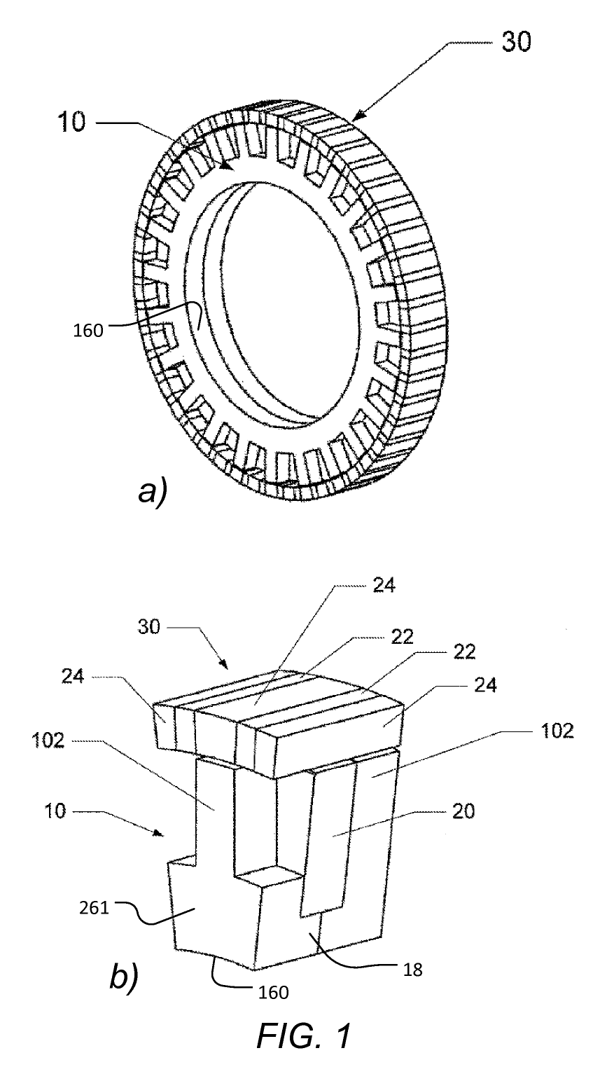

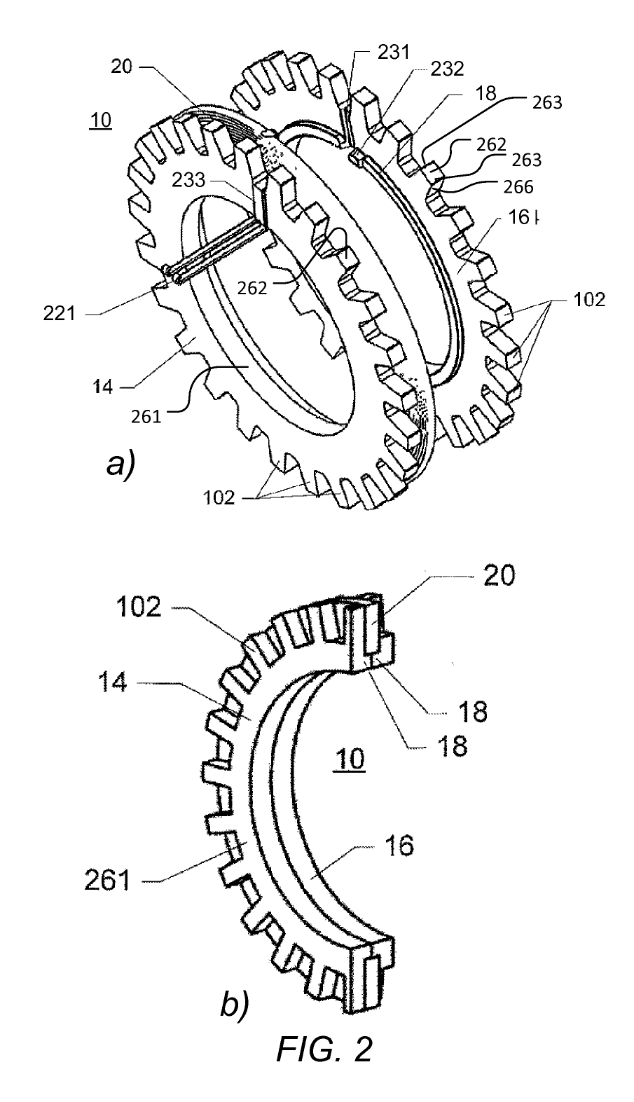

FIG. 1 illustrates an example of a modulated pole machine. In particular, FIG. 1 shows the active parts of a single phase, e.g. a one-phase machine or a phase of a multi-phase machine. FIG. 1a shows a perspective view of the active parts of the machine including a stator 10 and a rotor 30. FIG. 1b shows an enlarged view of a part of the machine. FIG. 2 illustrates an example of the stator 10 of the modulated pole machine of FIG. 1. In particular, FIG. 2a shows an exploded view of the stator 10, illustrating two stator core components 14, 16, and a coil 20. FIG. 2b shows a cut-view of the stator 10.

The machine comprises a stator 10 which comprises a central single coil 20 that magnetically feeds multiple teeth 102 formed by a soft magnetic stator core structure. While in other common electrical machine structures the coil is formed around the individual teeth of the stator core, the coil 20 of the stator of FIG. 1 is sandwiched between the teeth of the stator core. More particularly the modulated pole machine of FIGS. 1 and 2 comprises two stator core components 14, 16 each including a plurality of teeth 102 and being substantially annular, a coil 20 arranged between the first and second annular stator core components, and a rotor 30 including a plurality of permanent magnets 22. Further, the stator core components 14, 16, the coil 20 and the rotor 30 encircle a common geometric axis, and the plurality of teeth 102 of the two stator core components 14, 16 are arranged to protrude towards the rotor 30 for forming a closed circuit flux path. The stator teeth of the two stator core components 14, 16 are circumferentially displaced in relation to each other.

Each stator core component comprises an annular portion 261 and a circumferential flange 18 forming a flux bridge or yoke component that provides an axial flux path between circumferentially displaced teeth of the two stator core components. Each stator core component 14, 16 may be formed as an annular disc having a central, substantially circular opening defined by a radially inner edge 160 of the annular portion 261. The annular part 261 between the inner edge 160 and the teeth 102 provides a flux path and a side wall of a circumferential cavity accommodating the coil 20. The circumferential flange 18 is located at or near the inner edge. In the assembled stator the circumferential flange 18 is arranged on the inner side of the stator core component, i.e. on the side facing the coil 20 and the other stator core component.

In the machine of FIGS. 1 and 2 the stator teeth protrude in a radially outward direction towards the rotor which surrounds the stator. However, the stator could equally well be placed exteriorly with respect to the rotor and with the stator teeth extending radially inward, i.e. embodiments of the rotor and the stator described herein may be used in inner and outer rotor machines.

The active rotor structure 30 is built up from an even number of segments 22, 24 wherein half of the number of segments—also called rotor pole pieces 24—are made of soft magnetic material and the other half of the number of segments are made of permanent magnetic material 22. These segments may be produced as individual components. The permanent magnets 22 are arranged so that the magnetization directions of the permanent magnets are substantially circumferential, i.e. the north and the south poles, respectively, face in a substantially circumferential direction. Further, every second permanent magnet 22, counted circumferentially is arranged having its magnetization direction in the opposite direction in relation to its neighbouring permanent magnets. The magnetic functionality of the soft magnetic pole pieces 24 in the machine structure is fully three dimensional and each soft magnetic pole piece 24 is able to efficiently carry varying magnetic flux with high magnetic permeability in all three space directions.

This design of the rotor 30 and the stator 10 has the advantage of enabling flux concentration from the permanent magnets 22 so that the surface of the rotor 30 facing a tooth of the stator 10 may present the total magnetic flux from both of the neighboring permanent magnets 22 to the surface of the facing tooth. The flux concentration may be seen as a function of the area of the permanent magnets 22 facing each pole piece 24 divided with the area facing a tooth. In particular, due to the circumferential displacement of the teeth, a tooth facing a pole piece results in an active air gap that only extends partly across the axial extent of the pole piece. Nevertheless, the magnetic flux from the entire axial extent of the permanent magnets is axially and radially directed in the pole piece towards the active air gap. These flux concentration properties of each pole piece 24 make it possible to use weak low cost permanent magnets as permanent magnets 22 in the rotor and makes it possible to achieve very high air gap flux densities. The flux concentration may be facilitated by the pole piece being made from magnetic powder enabling effective three dimensional flux paths. Further, the design also makes it possible to make more efficient use of the magnets than in corresponding types of machines.

The stator 10 comprises two identical stator core components 14, 16, each comprising a number of teeth 102; however, in alternative embodiments, the stator may be assembled from stator core components having different shapes. Each stator core component is made of soft magnetic powder, compacted in one piece in a press tool. When the stator core components have identical shapes, they may be pressed in the same tool. The two stator core components are then joined in a second operation, and together form the stator core with radially extending stator core teeth, where the teeth of one stator core component are axially and circumferentially displaced relative to the teeth of the other stator core component.

Each of the teeth 102 has an interface surface 262 facing the air gap. During operation of the machine, the magnetic flux is communicated through the interface surface 262 via the air gap and through a corresponding interface surface of a pole piece of the rotor. The interface surface 262 is delimited in the circumferential direction, i.e. along the direction of motion of the rotor, by edges 263. The edges 263 connect the interface surface 262 with the respective side faces 266 of the tooth that face the neighbouring teeth.

As illustrated in FIG. 2a, the coil 20 has two connecting wires 221 for providing electrical current to the coil. The connecting wires may connect to the coil at different circumferential and/or radial positions. The stator core components 14, 16 are provided with an elongated recess forming a wire channel 231 that extends radially along the inner side of each stator core component so as to allow at least one of the wires to be fed radially along the coil, and both wires to be fed axially away from the coil at substantially the same position. In the example of FIG. 2a, the stator core component is further provided with an indexing protrusion 232, e.g. as part of the flange 18, shaped and sized to be partly inserted in the wire channel of another stator component so as to facilitate proper alignment of both stator core components relatively to each other during assembly. It will be appreciated however, that other embodiments of stator core components may be provided with no or different wire channels and/or with no or different indexing features.

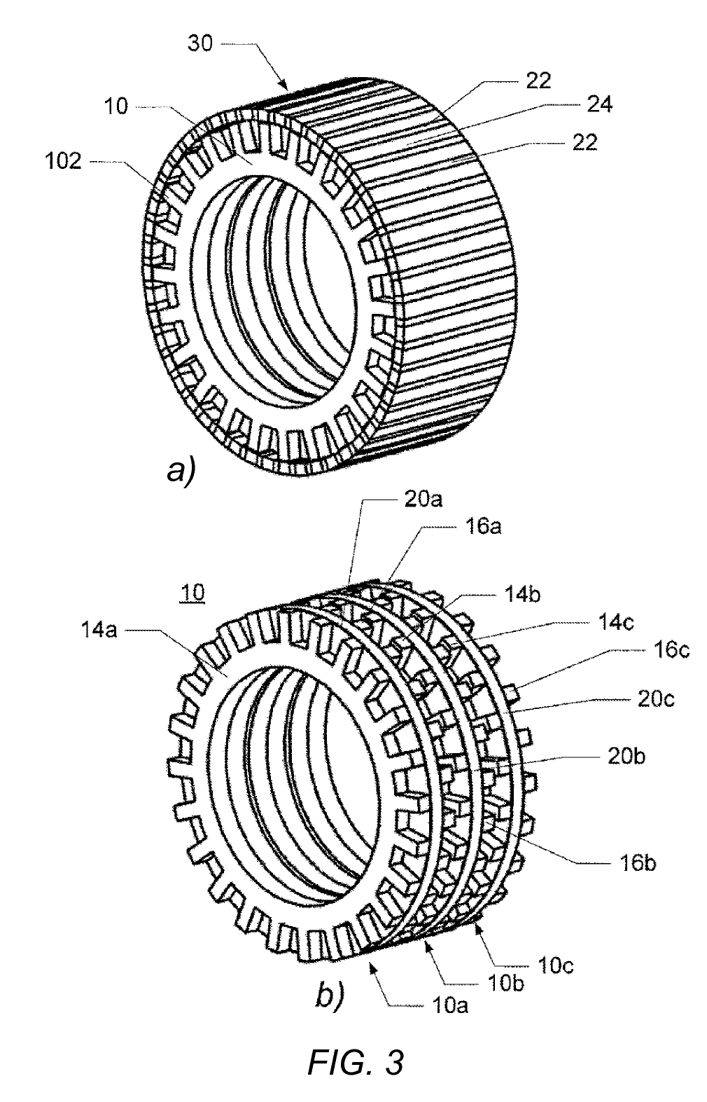

The single-phase stator 10 may be used as a stator of a single-phase machine as illustrated in FIGS. 1 and 2, and/or as one phase of a multi-phase machine, e.g. as one of the stator phases 10a-c of the machine of FIG. 3.

In particular, FIG. 3a illustrates an example of a 3-phase modulated pole machine, while FIG. 3b shows an example of a stator of the machine of FIG. 3a. The machine comprises a stator 10 and a rotor 30. The stator 10 contains three stator phase components 10a, b, c each as described in connection with FIGS. 1 and 2. In particular, each stator phase component comprises a respective stator component pair 14a, 16a; 14b, 16b; and 14c, 16c, respectively, each holding one circumferential coil 20a-c, respectively.

Hence, as in the example of FIGS. 1 and 2, each electric modulated pole machine stator phase component 10a-c of FIG. 3 comprises a central coil 20a-c, e.g. a single coil, that magnetically feeds multiple teeth 102 formed by the soft magnetic core structure. More particularly, each stator phase 10a-c of the shown electric modulated pole machine comprises two stator core components 14, each including a plurality of teeth 102 and being substantially annular, a coil 20 arranged between the first and second circular stator core components. Further, the stator core components 14 and the coil 20 of each stator phase encircle a common axis, and the plurality of teeth 102 of the stator core components 14 are arranged to protrude radially outward. In the example of FIG. 3 the rotor 30 is arranged coaxially with the stator 10 and encircling the stator so as to form an air gap between the teeth 102 of the stator and the rotor. The rotor may be provided as alternating permanent magnets 22 and pole pieces 24 as described in connection with FIGS. 1 and 2, but axially extending across all stator phase components, i.e. a single rotor structure is provided serving all three phases. It will be appreciated, however, that in other embodiments the rotor may be provided as three separate cylindrical rotors arranged in axial extension from each other. In yet other embodiments some or all of the rotor components, e.g. the permanent magnets 22 may be provided as a series of shorter components, each having the axial extent of a single phase only.

The embodiments of the stator described in connection with FIGS. 1-3 have teeth without so-called claws. However, small claws may be added without increase of tool cost and still improving the motor performance.

The phases of the stator of FIG. 3 are made up of separate stator core components. However, in alternative embodiments, the stator core of neighbouring phases may be combined into the same component, e.g. as described in WO 2011/033106 the entire content of which are hereby incorporated herein by reference.

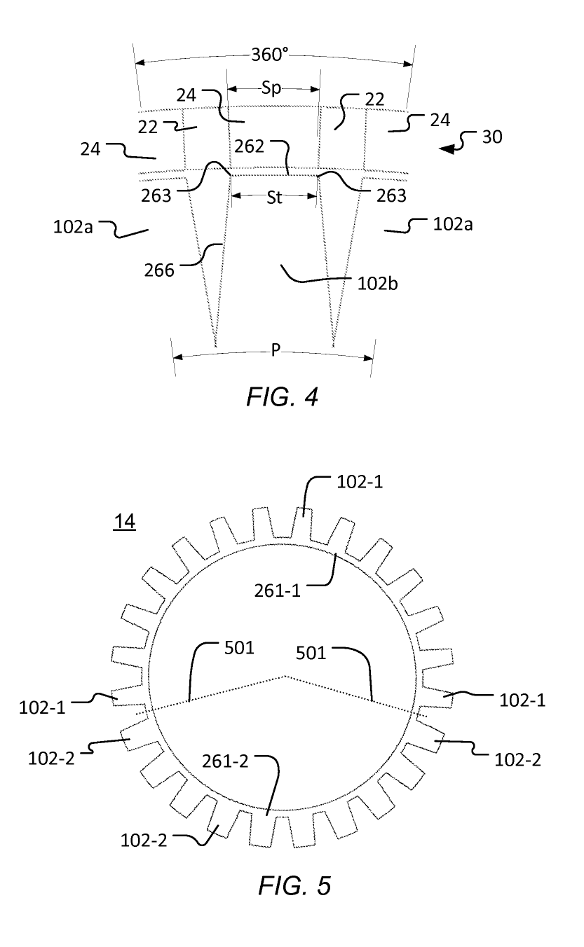

FIG. 4 shows an enlarged view of a portion of an example of a stator and a rotor of a modulated pole machine. In particular, FIG. 4 illustrates two neighbouring teeth 102a of one of two stator core components, as well as a tooth 102b of the other of the two stator core components of the same stator core or the same stator core phase. FIG. 4 further shows a portion of the rotor 30. The rotor comprises permanent magnets 22 and pole pieces 24. Each tooth has an interface surface 262 delimited in the circumferential direction by edges 263 between the interface surface 262 and the respective side walls 266 of the tooth. The circumferential extent of the interface surface defines the tooth span St of the tooth. The tooth span may be expressed as a length, e.g. in mm. Alternatively, as illustrated in FIG. 4, the tooth span may conveniently be expressed in electrical degrees, i.e. as an angle relative to the angle corresponding to a complete electrical cycle. A complete electrical cycle corresponds to 360° as illustrated in FIG. 4. Similar to the tooth span, the extent of each pole pieces 24 in the circumferential direction defines a pole span Sp.

The ratio of pole span to tooth span can be changed by changing the tooth span while keeping the same magnet thickness (i.e. the circumferential extent of the permanent magnets 22) and, hence, pole span constant. Changing the tooth span has less of an influence on the magnitude of the fundamental back EMF, unlike changing the magnet thickness, and is hence a much more predictable way of tuning the harmonics.

FIG. 4 further illustrates the pitch distance P between teeth 102a, here measured as the distance between the respective centres of the teeth. Alternatively, the pitch may be measured as the distance between respective side faces facing the same direction of the teeth 102a.

FIG. 5 shows a side view of an example of a stator core component. The stator core component of FIG. 5 is similar to the stator core components shown in FIGS. 1 and 2, in that it comprises an annular part 261 from which teeth 102-1, 102-2 extend radially outward. The teeth are distributed around the outer circumference of the annular part 261. The annular part 261 comprises a first segment 261-1 and a second segment 261-2 that together form a complete ring. The border between the first and second segments is illustrated in FIG. 5 by dashed line 501. The teeth 102-1 extending from the first segment 261-1 have a first tooth span, while the teeth 102-2 in the second segment 261-2 have a second, different tooth span. In the example of FIG. 5, there are fewer teeth in the subset of teeth 102-2 extending from the second segment 261-2 than in the subset of teeth 102-1 that extend from the first segment 261-1.

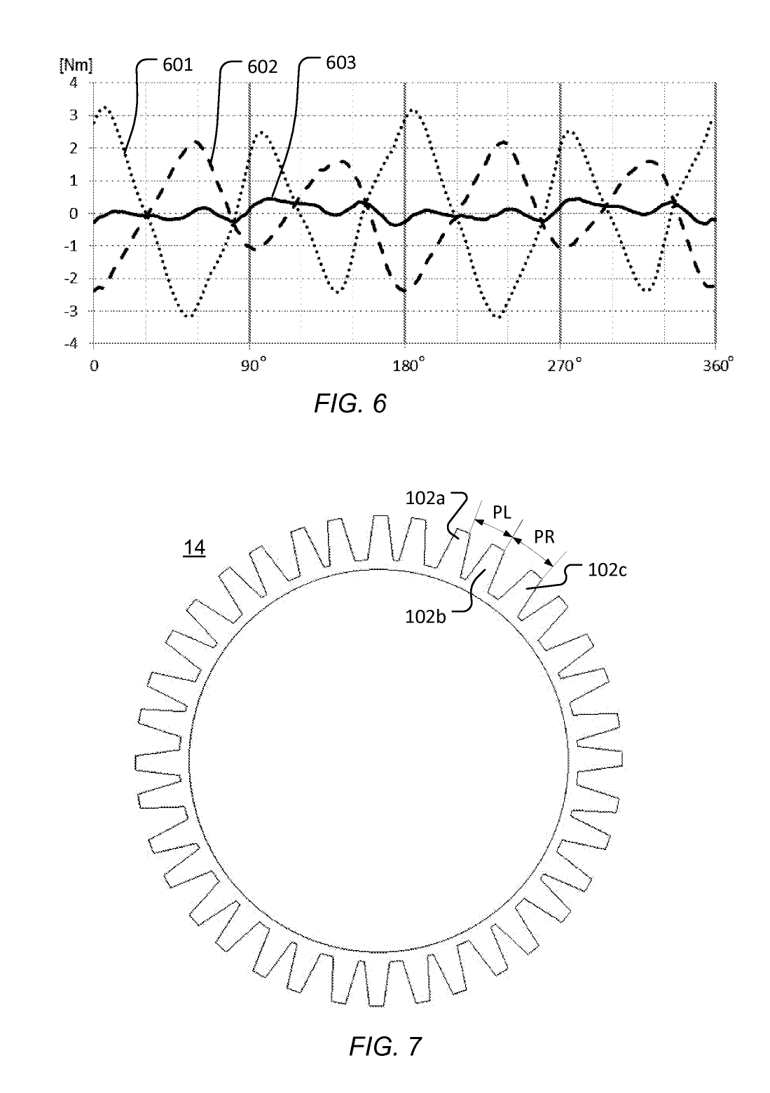

FIG. 6 shows results from finite element simulations of an example of a modulated pole machine as described herein. In particular, FIG. 6 shows the cogging torque in Nm as a function of the rotor angle in electrical degrees for a three phase machine similar to the machine of FIG. 3 but with 48 poles and with different tooth spans. Curve 601 shows the cogging torque for a machine with a uniform tooth span of 120°, while curve 602 shows the cogging torque for a uniform tooth span of 170°. Finally, curve 603 shows the cogging torque for a machine with 14 teeth having a 170° tooth span and 10 teeth having a 120° tooth span.

As can be seen in FIG. 6, the two cogging torques for a 120° tooth span (curve 602) and for a 170° tooth span (curve 601) are in antiphase with each other. Hence, as the cogging torque of the machine is made up of the sum of all 24 teeth, a combination of the two tooth spans cancels the cogging torque. Consequently, as can be seen in FIG. 6, the cogging torque of the machine with varying tooth span (curve 603) is significantly reduced.

The inventors have further found that a combination of different tooth spans further reduces the effect of harmonics in the back EMF waveform of the machine. Certain harmonics in the back EMF also change phase with changes in tooth span and, hence, the tooth span can be used to cancel these harmonics.

Since the size of the tooth span is a continuous value, and since the number of subsets of different tooth spans and the number of teeth in each subset may be varied, there are in fact a vast number of possible combinations of tooth spans and, for a given machine design, the skilled person will be able to find an optimum combination for reducing cogging torque, harmonic content or for the best compromise between the two. In particular, during the design of a machine, the effects of different tooth spans may be simulated using known techniques of finite element analysis.

Having different tooth spans may in some situations lead to unbalanced forces in the machine, even though the variation in forces between different tooth spans is low. However, if the difference in forces for a particular design become high the teeth with each tooth span can be distributed around the periphery of the machine in order to cancel the forces out.

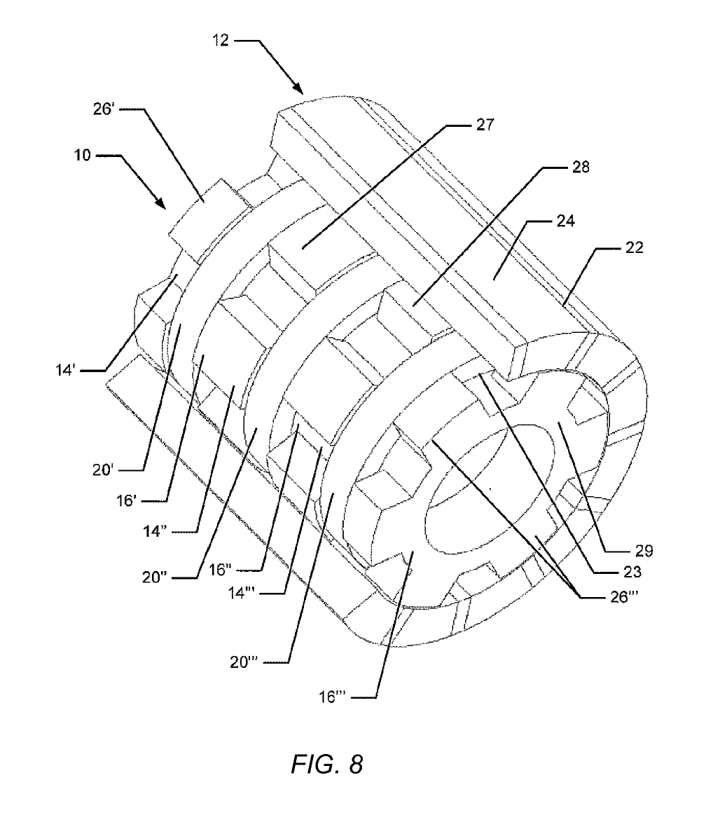

FIG. 7 illustrates a stator core component 14 of a stator where the pitch distance between neighbouring teeth varies, a method also referred to as pitching. In particular, each tooth 102b has a different pitch distance PL to its left neighbour 102a that is different than the pitch distance PR to its right neighbour 102c. However, the distance to right and left next neighbours is constant and uniform for all teeth, i.e. the sum PL+PR=360° is the same for each tooth.

It has turned out, that a combination of varying tooth span and varying pitch distance provides a further reduction of the cogging torque and harmonic content of the back EMF.

Changing the tooth span and pitching of the teeth have both been investigated by means of a finite element analysis of a three-phase machine similar to the machine shown in FIG. 3. This analysis has shown that both methods reduce the harmonic content of the back EMF and cogging torque. Table 1 sums up the some combinations of varying tooth span and pitching.

All the pitched situations reduce the total harmonic distortion (THD) of the back EMF waveforms; the inner phase of the three phase machine was influenced the most as it had a higher seventh harmonic content that pitching in this embodiment aimed to remove.

Changing the tooth span also affects the THD but can also reduce cogging torque significantly. For a given machine design, an optimum combination of solutions may thus be determined. However, whether the harmonic content or cogging torque is focused on will be entirely application specific.

TABLE 1
Summary of influence of stator changes on the properties of
the a three-phase modulated pole machine - THD is for the
first eight harmonics with triplens ignored due to the star
connection of the specific machine under investigation.

| | Before | | | | |
|---|---|---|---|---|---|
| | Changes | Combi- | Pitched | Pitched | Pitched and |
| | (130 deg | nation | (130 deg | (150 deg | combination |
| | span) | of spans | span) | span) | of spans¹ |
| Drop in | 0% | 1.80% | 4.59% | 8.34% | 7.04% |
| fundamental | | | | | |
| EMF | | | | | |
| Peak | 3.69 | 0.44 | 1.95 | 0.79 | 0.55 |
| Cogging | | | | | |
| (N · m) | | | | | |
| Outer Phase | 2.85% | 2.97% | 1.70% | 1.84% | 1.90% |
| THD | | | | | |
| Inner Phase | 6.51% | 5.16% | 2.34% | 3.73% | 3.55% |
| THD | | | | | |

The first column shows results for the machine with a constant pitch and constant tooth span. The second column shows corresponding results for a machine with varying tooth spans but constant pitch. The third and forth columns show results for a machine with varying pitch (aiming to reduce the 7^{th} harmonic in the back EMF) but for respective constant tooth spans, while the last column shows results for machine where both the tooth span and the pitch was varied. The combination of spans in the last column was ten teeth of 170°, four teeth of 150° and ten teeth of 140°.

The inner phase of the three-phase machine still shows a higher THD in all cases, this was found to be generally due to the tooth spans increasing the fifth harmonic content of the inner phase. It may be more useful to pitch so as to reduce the sixth harmonic which will suppress both the fifth and seventh harmonic and may show an improvement in the THD.

Methods have thus been described which allow a modulated pole machine to have a back EMF low in harmonic content, whilst also having a low cogging torque.

FIG. 8 shows a stator 10 and a rotor 12 of an example of a 3-phase modulated pole machine having combined phases. The reference numerals with ‘refer to a feature of a first phase, “to a feature of a second phase, and”’ to a feature of a third phase. The stator 10 comprises three phases, where each phase comprises a coil 20, a first stator core component 14 and a second stator core component 16. One rotor 12 is shown which encloses the stator 10. The rotor 12 comprises permanent magnets 22 and rotor pole sections 24 extending along the entire stator 10. An axle onto which the stator is mounted may be provided (not shown). Each stator core component 14, 16 is essentially circular in shape and includes a stator core back section 29 and a plurality of radially extending teeth which extend from the stator core back section. The teeth are arranged to extend outwards towards the rotor 12 for forming a closed circuit flux path with the rotor 12. An annular stator core part 29 connects the teeth in the circumferential direction. The stator core components further comprise a yoke section 23 extending axially from the annular stator core part 29 towards the neighbouring stator core component so as to provide an axial flux bridge.

The second stator core component 16′ of phase 1 and the first stator core component 14″ of phase 2 are arranged as one unit, i.e. a combined stator core component, whereby phase 1 and phase 2 share a stator core component. Thus the teeth 27 of the combined phase unit are arranged to be shared between phase 1 and phase 2, whereby the set of teeth of the first stator section 14″ of phase 2 and the set of teeth of the second stator core component 16′ of phase 1 are formed as one unit.

The teeth 28 of the combined phase unit are arranged to be shared between phase 2 and phase 3, whereby the set of teeth of the first stator section 14″′ of phase 3 and the set of teeth of the second stator core component 16″ of phase 2 are formed as one unit.

The teeth 26 at each end of the stator 10 are not shared between two phases, and thus the teeth 26′ belong only to phase 1 and the teeth 26″′belongs only to phase 3. Furthermore, the teeth 26′ and 26″′ of the peripheral phases 1 and 3 define the axial extent of the active air gap region of the stator which axially extends between the peripheral edges of the teeth 26′ and 26″′, respectively. The permanent magnets 22 and pole sections 24 extend axially across the entire active air gap region, i.e. between the axially outer edges of the surfaces of teeth 26′ and 26″′ facing the rotor.

The teeth of each set of teeth 26′, 27, 28, and 26′″, respectively, may be arranged as two or more subsets of teeth having respective tooth spans in the circumferential direction as described herein. Additionally, the pitch between the teeth may be varied. Alternatively, the tooth spans and/or pitch of only one or some of the phase units may be varied.

Although some embodiments have been described and shown in detail, the invention is not restricted to them, but may also be embodied in other ways within the scope of the subject matter defined in the following claims. In particular, it is to be understood that other embodiments may be utilised, and that structural and functional modifications may be made without departing from the scope of the present invention.

Embodiments of the invention disclosed herein may be used for a direct wheel drive motor for an electric-bicycle or other electrically driven vehicle, in particular a light-weight vehicle. Such applications may impose demands on high torque, relatively low speed and low cost. These demands may be fulfilled by a motor as described herein.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A stator core component for a stator of a modulated pole machine, the modulated pole machine comprising the stator and a rotor, the stator and the rotor defining an air gap between respective interface surfaces of the rotor the stator for communicating magnetic flux between the stator and the rotor,
wherein the stator core component comprises an annular part from which a plurality of teeth extend in a radial direction towards the rotor, the teeth being arranged along a circumference of the annular part, each tooth having an interface surface facing the air gap and adapted to allow magnetic flux to communicate between the stator and the rotor via the air gap, the interface surface of each tooth defining a tooth span in the circumferential direction of the tooth;
wherein the stator core component comprises at least a first subset of teeth having a first tooth span and a second subset of teeth having a second tooth span, different from the first tooth span.

2. A stator core component according to claim 1, wherein the first subset of teeth are arranged in an alternating pattern.

3. A stator core component according to claim 1, wherein at least some of the teeth are positioned such that they have different pitch distances to their respective neighbouring teeth.

4. A stator core component according to claim 1, wherein the first and second tooth spans are selected so as to cause different cogging torque waveforms.

5. A stator core component according to claim 1, wherein the first subset of teeth comprises a different number of teeth than the second subset of teeth.

6. A stator core component according to claim 1, wherein the stator core component is made from soft magnetic powder.

7. A stator for a modulated pole machine, the modulated pole machine comprising the stator and a rotor, the stator and the rotor defining an air gap between respective interface surfaces of the rotor the stator for communicating magnetic flux between the stator and the rotor,
wherein the stator comprises stator core comprising at least one annular part from which a plurality of teeth extend in a radial direction towards the rotor, the teeth being arranged along a circumference of the annular part, each tooth having an interface surface facing the air gap and adapted to allow magnetic flux to communicate between the stator and the rotor via the air gap, the interface surface of each tooth defining a tooth span in the circumferential direction of the tooth;
wherein the stator core comprises at least a first subset of teeth having a first tooth span and a second subset of teeth having a second tooth span, different from the first tooth span.

8. A stator for a modulated pole machine, the modulated pole machine comprising the stator and a rotor, the stator and the rotor defining an air gap between respective interface surfaces of the rotor the stator for communicating magnetic flux between the stator and the rotor, wherein the stator core comprises two stator core components as defined claim 1, arranged side by side in the axial direction, wherein the teeth of the stator core components are displaced relative to each other in the circumferential direction.

9. A stator according to claim 8, comprising a coil arranged between the stator core components.

10. A stator according to claim 9, wherein each of the teeth comprises a base part and a claw member extending from the tooth towards the coil, wherein the claw part defines the interface surface.

11. A modulated pole machine comprising a stator as defined in claim 7, a rotor, and an air gap between respective interface surfaces of the rotor the stator for communicating magnetic flux between the stator and the rotor, the rotor being adapted to move relative to the stator in a direction of motion.

12. A modulated pole machine according to claim 11, wherein the rotor is configured to generate a rotor magnetic field for interaction with a stator magnetic field of the stator, the rotor comprising a plurality of permanent magnets magnetised in the circumferential direction of said rotor so as to generate the rotor magnetic field, the permanent magnets being separated from each other in the circumferential direction of the rotor by axially extending rotor pole pieces for directing the rotor magnetic field generated by said permanent magnets in at least a radial and an axial direction.

13. A modulated pole machine according to claim 11, wherein the stator and/or the rotor provide a three-dimensional (3D) flux path including a flux path component in the axial direction.

14. A modulated pole machine according to claim 11, wherein the modulated pole machine is a multi-phase machine having two outer phases and one or more central phases.

15. A modulated pole machine according to claim 11, wherein the rotor pole pieces each have a pole span in the circumferential direction; wherein the first subset of teeth have a tooth span larger than the pole span and wherein the second subset of teeth have a tooth span smaller than the pole span.
